(19) United States
(12) Patent Application Publication
(10) Pub. No.: US 2011/0073738 A1
(43) Pub. Date: Mar. 31, 2011

(54) Display Device

(76) Inventor: Mitsuyoshi Takao, Hidaka-shi (JP)

(21) Appl. No.: 12/855,907

(22) Filed: Aug. 13, 2010

(30) Foreign Application Priority Data
Sep. 30, 2009 (JP) 2009-228930

(51) Int. Cl. F16M 11/38

(52) U.S. Cl. 248/397

(57) ABSTRACT

A display device includes: an adjustment mechanism including: a first bearing portion provided in a body; a first pin including a first cam portion provided so as to be concentric with the center axis of the first bearing portion; a first opening portion provided in a stand, the first opening portion being formed with a first hole through which a head portion of the first pin passes and a second hole into which the first cam portion is fitted; a second bearing portion including a second cam portion provided so as to be eccentric to the center axis of the second bearing portion; and a second opening portion provided in the stand, the second opening portion being formed with a third hole through which a head portion of the second pin passes and a fourth hole into which the second cam portion is fitted.

### CROSS REFERENCE TO RELATED APPLICATION(S)

The present disclosure relates to the subject matters contained in Japanese Patent Application No. 2009-228930 filed on Sep. 30, 2009, which are incorporated herein by reference in its entirety.

### BACKGROUND

1. Field

The present invention relates to a display device in which the tilt of a body of the display device can be adjusted.

2. Description of the Related Art

Increase in screen size of a flat-screen TV using a display panel such as a liquid crystal display panel or a PDP (Plasma Display Panel) has advanced in recent years, so that a large number of flat-screen TVs each having a screen size (i.e. a diagonal length of an effective visible region) of 40 inches or larger have been produced on a commercial basis. This type flat-screen TV is externally shaped like a rectangular flat panel which has a screen aspect ratio of 16:9 so as to be landscape-oriented. For this reason, if the tilt of the outer shape of the flat-screen TV around the display screen or the tilt of the installation surface of the display screen from a vertical plane is large, displacement due to the tilt is conspicuous in an end portion of the outer shape of the large-size flat-screen TV so that the commodity value thereof is significantly spoiled deteriorated.

For example, the following device has been disclosed as a thin display device with an adjustment mechanism for keeping a display screen horizontal. A display device including a body, a stand for supporting the body, and an adjustment mechanism provided between the body and the stand and capable of adjusting the tilt of the body, wherein: the adjustment mechanism has a first positioning portion, and a second positioning portion provided independently of the first positioning portion; the first positioning portion performs positioning of the body relative to the stand; and the second positioning portion rotates the body by a predetermined angle with use of the first positioning portion as a fulcrum relative to the stand and performs positioning of the body relative to the stand in the condition that the body is rotated by the predetermined angle.

In the display device disclosed in JP-A-2008-186003, a hook mechanism for temporarily stopping the body is provided separately from the tilt adjustment mechanism, so that it is necessary to hook the hook mechanism of the body on the top of the stand at the time of assembling the stand and the body. Then, after the body is temporarily stopped by setscrews, a cam portion of an alignment pin thread-engaged with a bearing portion of the stand is inserted into an opening portion of the body while the alignment pin is rotated by a screwdriver. There is however a problem that the cam portion of the pin could not be inserted into the opening portion of the body well because of dimensional error of the position of the hook mechanism or dimensional error of screw holes corresponding to the setscrews. Moreover, because it is necessary to provide the hook mechanism separately as described above, it is necessary to secure the place where the hook mechanism is provided while the cost of the hook mechanism is required.

In addition, there is a possibility that the angle of rotation obtained by only the second cam would be too small to correct the tilt of the body when the body is rotated on the first positioning portion as a fulcrum.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a perspective view showing an outline of a display device according to the invention;

FIG. 2 is a rear view showing the display device;

FIG. 3 is a sectional view taken along the line A-A in FIG. 2;

FIG. 4 is a schematic perspective view of a stand, taken from a rear side;

FIG. 5 is a schematic perspective view of a joint state of the stand and a frame, taken from the rear side;

FIG. 6 is a perspective view showing an outline of a first pin;

FIG. 7 is a perspective view showing an outline of a second pin;

FIGS. 8A to 8C are enlarged views showing a joint portion where a support portion of the stand and the frame are joined to each other;

FIGS. 9A to 9C are enlarged views showing a joint portion where a support portion of the stand and the frame are joined to each other;

FIG. 10 is a rear view showing an operation of the frame;

FIG. 11 is a perspective view showing the outline of a first pin in an aspect;

FIGS. 12A and 12B are enlarged views showing a joint portion where a support portion of a stand and a frame are joined to each other in the aspect; and

FIG. 13 is a rear view showing an operation of the frame in the aspect.

### DETAILED DESCRIPTION OF THE EMBODIMENTS

Embodiments of the invention will be described below with reference to the drawings.

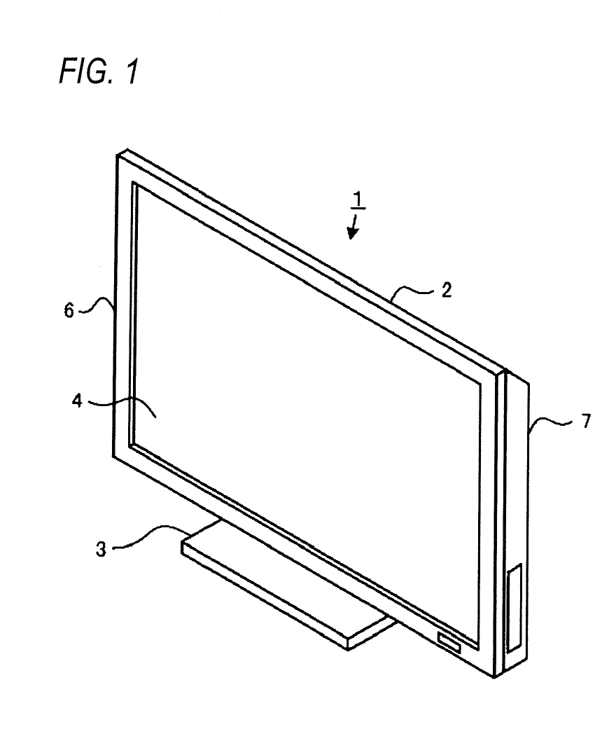

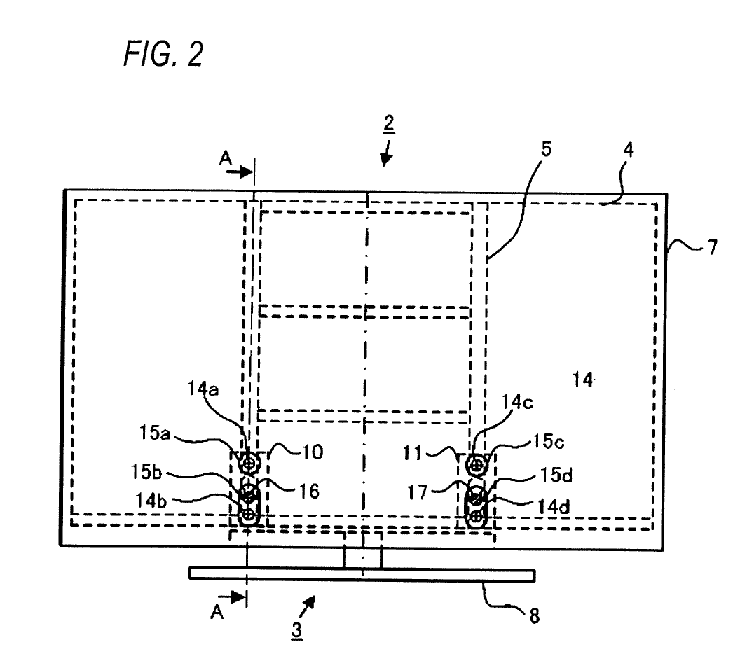

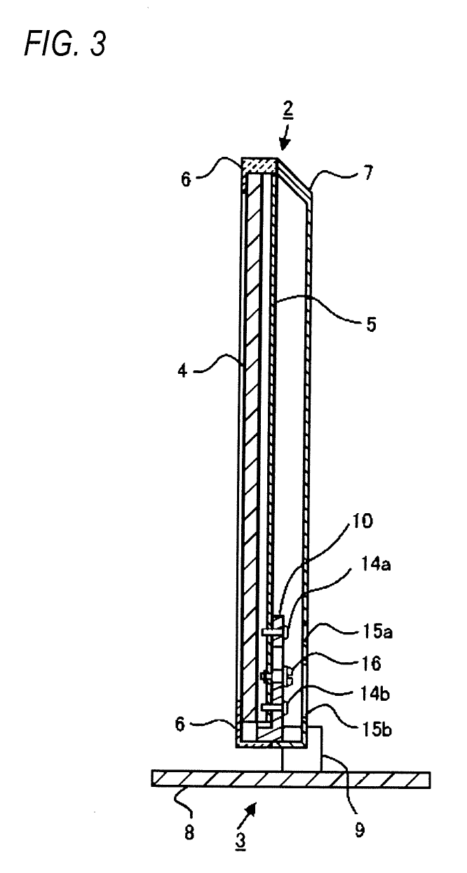

FIG. 1 is a perspective view showing an outline of a display device 1 according to the invention. FIG. 2 is a rear view of the display device 1. FIG. 3 is a sectional view of the display device 1 taken along the line A-A in FIG. 2. As shown in FIG. 1, the display device 1 includes a body 2, and a stand 3 which supports the body 2. As shown in FIGS. 1, 2 and 3, the body 2 has a display panel 4 such as a liquid crystal display panel or a PDP which is disposed on a front side, and a frame 5 which is disposed on a rear side of the display panel 4 so that the display panel 4 is supported by the frame 5. A circuit board and a power supply circuit not shown but for driving the display panel are disposed in the frame 5. An outer surface of the body 2 is surrounded by a front cover 6 and a rear cover 7. A front surface of the body 2 and part of top, bottom and both side surfaces of the body 2 are covered with the front cover 6. A rear surface of the body 2 and part of top, bottom and both side surfaces of the body 2 are covered with the rear cover 7.

As shown in FIG. 2, the body 2 is joined to the stand 3 in a nearly central lower portion of the body 2 so as to be supported by the stand 3. Four screw fixing holes 12a to 12d are provided in two support portions 10 and 11 which are raised substantially vertically from a base 8 of the stand 3. On the other hand, fixing screw holes 13a to 13d not shown are provided in the frame 5. The frame 5 and the stand 3 are fixed to each other by setscrews 14a to 14d. For example, the frame 5 is formed by bending a metal plate 1-2 mm thick. Reinforcing members or the like are provided in the screw hole portions. Although four setscrews are described in this embodiment, it is a matter of course that a plurality of setscrews may be further added if necessary.

Opening portions 15a to 15b are provided in the rear cover so as to be located in positions corresponding to the setscrews 14a to 14d, so that the setscrews 14a to 14d can be tightened or loosened from the outside of the rear cover 7.

As shown in FIGS. 2 and 3, a first pin 16 is disposed as a tilt adjustment mechanism substantially in the center of the support portion 10 of the stand 3. On the other hand, a second pin 17 is disposed as a tilt adjustment mechanism substantially in the center of the support portion 11. The first pin 16 is a pin which is used as a center of rotation so that the horizontal tilt of the body 2 can be adjusted when the body 2 is rotated on the pin. The second pin 17 has an eccentric cam portion. When the second pin 17 is rotated, a rotation shaft of the second pin is moved up and down relative to the support portion 11 to thereby consequently rotate the body on the first pin 16 as a center of rotation to adjust the tilt of the body.

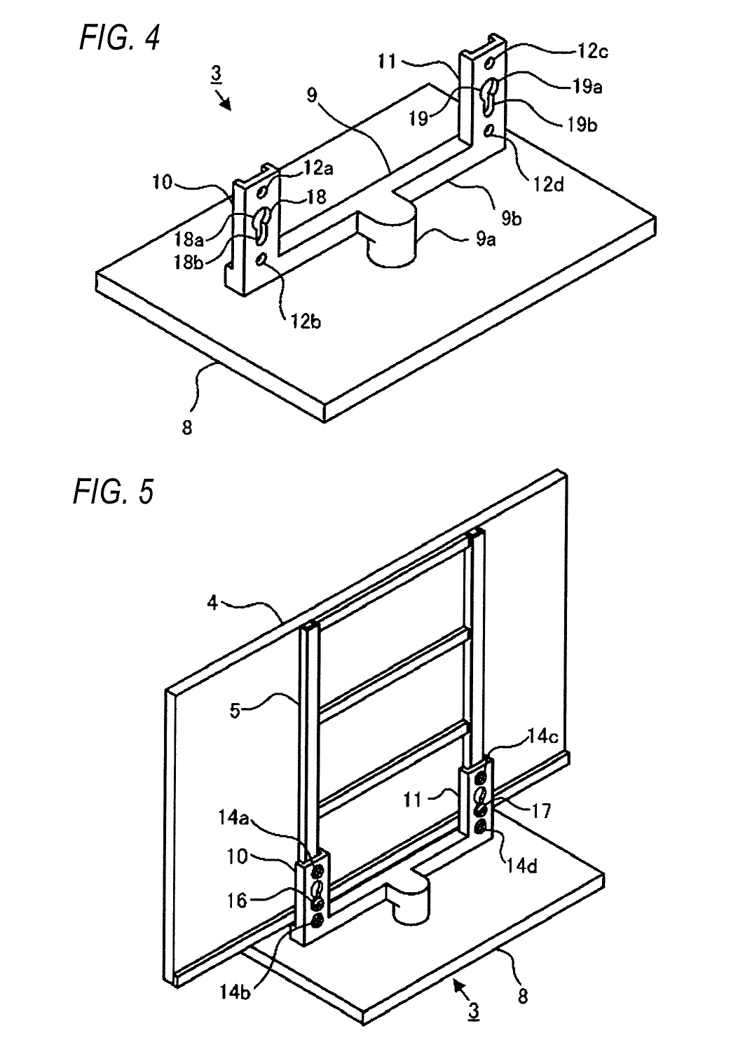

FIG. 4 is a schematic perspective view of the stand, taken from the rear side. A leg portion 9a is disposed substantially in the central portion of the base 8 of the stand 3. A U-shaped support member 9 is disposed on the leg portion 9a. The support member 9 is provided with the support portions 10 and 11 which are disposed on opposite sides of a rail portion 9b so as to extend substantially vertically with respect to the base 8. The leg portion 9a, the rail portion 9b and the support portions 10 and 11 are integrally molded by aluminum die-casting or the like.

A first opening portion 18 is provided between the screw fixing holes 12a and 12b in the support portion 10. The first opening portion 18 is composed of a first hole 18a substantially shaped like a circle and a U-shaped second hole 18b connected to a part of the first hole 18a. That is, the first opening portion 18 is provided as such a shape that a circular hole and an elliptic hole having a smaller width than the diameter of the circular hole are combined. For example, the first opening portion 18 is shaped like an electric bulb. On the other hand, a second opening portion 19 is provided between the screw fixing holes 12c and 12d in the support portion 11. The second opening portion 19 is composed of a third hole 19a substantially shaped like a circle and a U-shaped fourth hole 19b connected to a part of the third hole 19a. That is, the second opening portion 19 is provided as such a shape that a circular hole and an elliptic hole having a smaller width than the diameter of the circular hole are combined. For example, the second opening portion 19 is shaped like an electric bulb.

FIG. 5 is a schematic perspective view of a joint state of the stand 3 and the frame 5, taken from the rear side. In this state, the display panel 4 is attached to the frame 5. In the support portion 10, the frame 5 is fixed to the stand 3 by the screw fixing holes 12a and 12b, the screw holes 13a and 13b of the frame 5 and the setscrews 14a and 14b. The first pin 16 is disposed between the setscrews 14a and 14b. In the support portion 11, the frame 5 is fixed to the stand 3 by the screw fixing holes 12c and 12d, the screw holes 13c and 13d of the frame 5 and the setscrews 14c and 14d. The second pin 17 is disposed between the setscrews 14c and 14d.

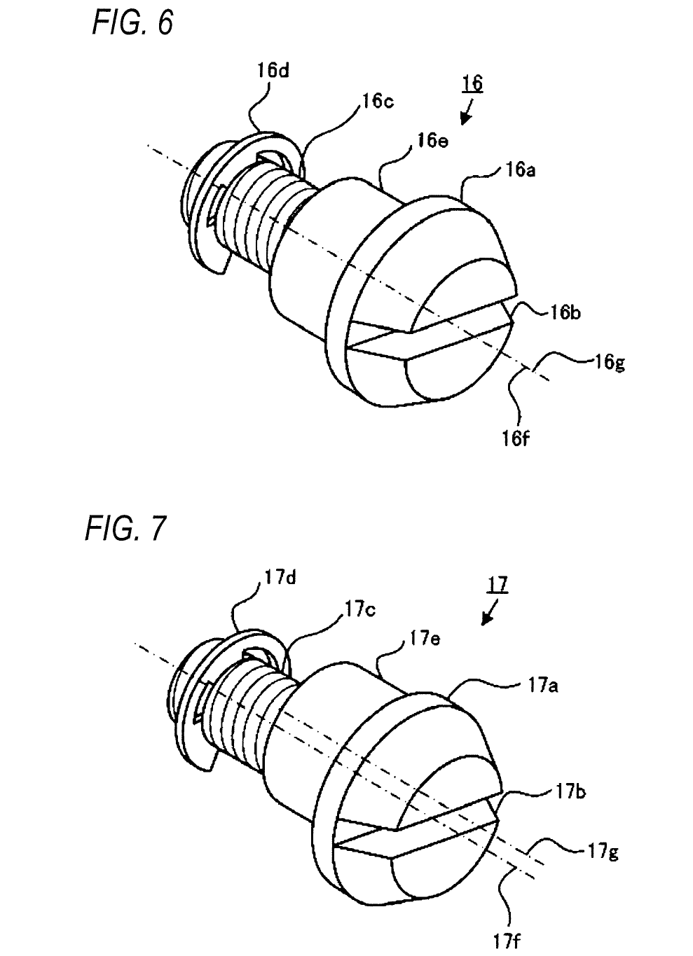

FIG. 6 is a perspective view showing the outline of the first pin 16. A slot 16b is provided in a head portion 16a so that the first pin 16 can be rotated by a slotted screwdriver. A thread portion 16c is provided on a side opposite to the head portion 16a. A snap ring 16d is provided in the rear of the thread portion 16c. A first cam portion 16e is provided between the head portion 16a and the thread portion 16c. A center axis 16f of the thread portion 16c and a center axis 16g of the first cam portion 16e are concentric. Incidentally, a snap ring may be provided in place of the head portion 16a.

FIG. 7 is a perspective view showing the outline of the second pin 17. A slot 17b is provided in a head portion 17a so that the second pin 17 can be rotated by a slotted screwdriver. A thread portion 17c is provided on a side opposite to the head portion 17a. A snap ring 17d is provided in the rear of the thread portion 17c. A second cam portion 17e is provided between the head portion 17a and the thread portion 17c. A center axis 17f of the thread portion 17c and a center axis 17g of the second cam portion 17e are eccentric. Incidentally, a snap ring may be provided in place of the head portion 17a.

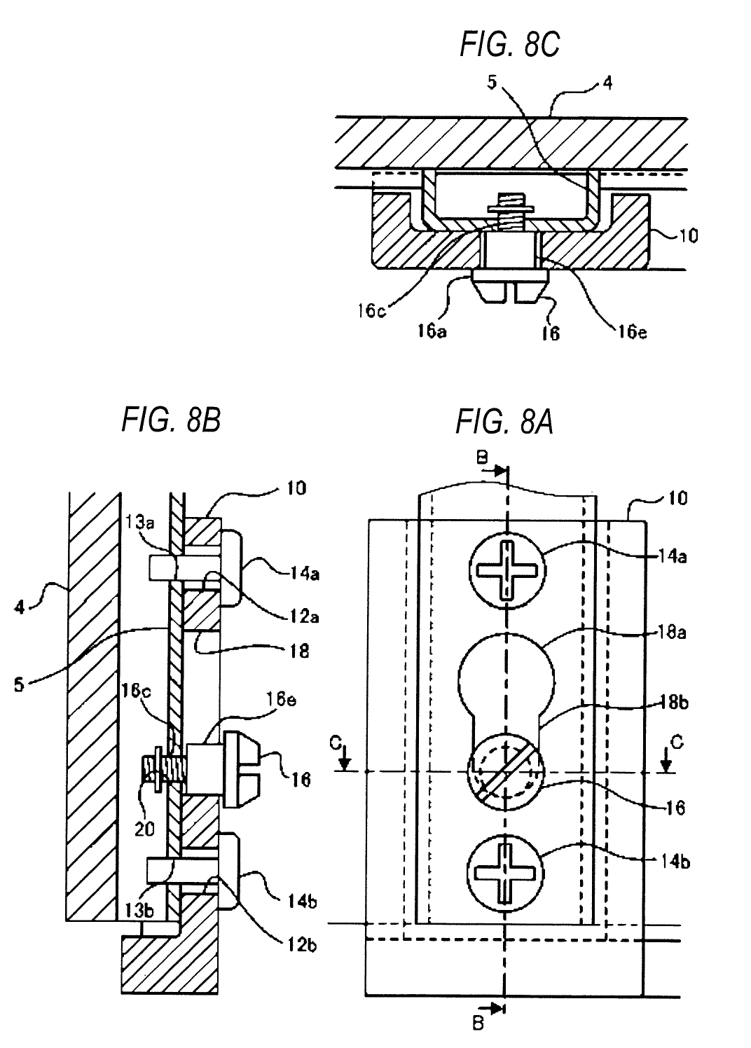

FIGS. 8A to 8C are enlarged views showing a joint portion of the support portion 10 of the stand 3 and the frame 5. FIG. 8A is a rear view showing a part of the support portion 10. The first opening portion 18 is composed of the first hole 18a substantially shaped like a circle and the U-shaped second hole 18b connected to a part of the first hole 18a. The first hole 18a is substantially shaped like a circle having a larger diameter than the outer diameter of the head portion 16a of the first pin 16. The second hole 18b is substantially shaped like a U figure having a width smaller than the outer diameter of the head portion 16a of the first pin 16 but larger than the outer diameter of the first cam portion 16e.

FIG. 8B is a sectional view taken along the line B-B in FIG. 8A. A first bearing portion 20 is provided in the frame 5. The first bearing portion 20 is formed as a female thread structure which is complementary to the thread portion 16c of the first pin 16. The thread portion 16c is formed as a screw mechanism capable of being thread-engaged with the first bearing portion 20, so that the first pin 16 can be rotated on the center axis of the first bearing portion 20 when the first pin 16 is rotated. After the first pin 16 is thread-engaged with the first bearing portion 20, the snap ring 16d is fitted onto the first pin 16 to prevent the first pin 16 from dropping out from the first bearing portion 20.

FIG. 8C is a sectional view taken along the line C-C in FIG. 8A. A section of the support portion 10 is shaped like a U figure opened toward the frame side. The support portion 10 is disposed so as to enclose a prop of the frame 5. According to this configuration, the body can be made thin because the distance between the display panel 4 and the rear surface of the support portion 10 can be reduced while the strengths of the frame 5 and the support portion 10 are ensured.

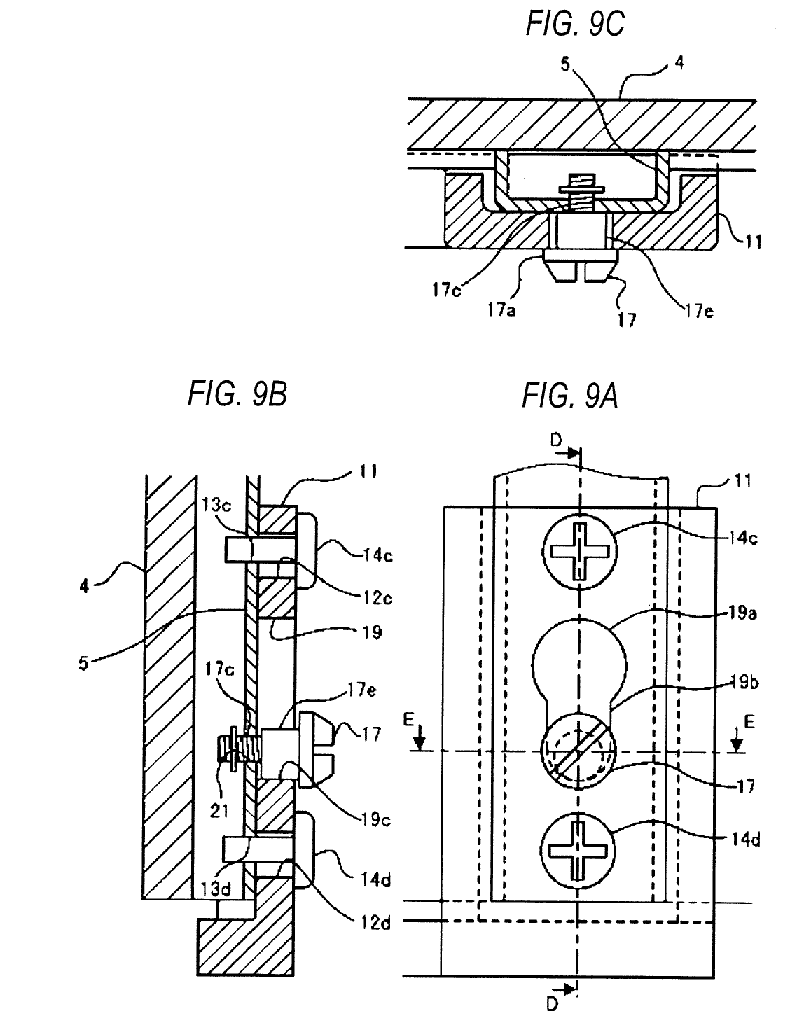

FIGS. 9A to 9C are enlarged views showing a joint portion of the support portion 11 of the stand 3 and the frame 5. FIG. 9A is a rear view showing a part of the support portion 11. The second opening portion 19 is composed of the third hole 19a substantially shaped like a circle and the U-shaped fourth hole 19b connected to a part of the third hole 19a. The third hole 19a is substantially shaped like a circle having a larger diameter than the outer diameter of the head portion 17a of the second pin 17. The fourth hole 19b is substantially shaped like a U figure having a width smaller than the outer diameter of the head portion 17a of the second pin 17 but larger than the outer diameter of the second cam portion 17e.

FIG. 9B is a sectional view taken along the line D-D in FIG. 9A. A second bearing portion 21 is provided in the frame 5. The second bearing portion 21 is formed as a female thread structure which is complementary to the thread portion 17c of the second pin 17. The thread portion 17c is formed as a screw mechanism capable of being thread-engaged with the second bearing portion 21, so that the second pin 17 can be rotated on the center axis of the second bearing portion 21. After the second pin 17 is thread-engaged with the second bearing portion 21, the snap ring 17d is fitted onto the second pin 17 to prevent the second pin 17 from dropping out from the second bearing portion 21.

FIG. 9C is a sectional view taken along the line E-E in FIG. 9A. A section of the support portion 11 is shaped like a U figure opened toward the frame side. The support portion 11 is disposed so as to enclose a prop of the frame 5. According to this configuration, the body can be made thin because the distance between the display panel 4 and the rear surface of the support portion 11 can be reduced while the strengths of the frame 5 and the support portion 11 are ensured.

As shown in FIGS. 8A, 8B, 9A and 9B, when the stand 3 is to be assembled with the frame 5 or the body 2, the head portion 16a of the first pin 16 attached to the frame 5 is inserted into the first hole 18a of the first opening portion 18 and the frame 5 or the body 2 is moved down. As a result, the head portion 16a is prevented from dropping out from the portion of the second hole 18b, so that a hook function can be fulfilled. Similarly, the head portion 17a of the second pin 17 attached to the frame 5 is inserted into the third hole 19a of the second opening portion 19 and the frame 5 or the body 2 is moved down. As a result, the head portion 17a is prevented from dropping out from the portion of the fourth hole 19b, so that a hook function can be fulfilled.

Tilt adjustment will be described next. As described above, the frame 5 or the body 2 is temporarily stopped in such a manner that the first and second pins 16 and 17 are hooked into the first and second opening portions 18 and 19 respectively and the setscrews 14a to 14d are then thread-engaged with the fixing screw holes 13a to 13d respectively.

As shown in FIG. 9A, the second pin 17 is provided with the second cam portion 17e eccentric to the center axis of the thread portion 17c. By rotating the second pin 17, the second cam portion 17e and a bottom 19c of the second opening portion 19 are brought into contact with each other. As a result, the height of the thread portion 17c changes, so that the height of the second bearing portion 21 changes. As a result, the frame 5 or the body 2 rotates on the first pin 16. After the tilt is adjusted, the setscrews 14a to 14d are tightened to obtain a fixed state. FIGS. 9A and 9B show a state in which the second cam portion 17e is located to be lower than the center axis so that the thread portion 17c is moved up relative to the bottom 19c by the degree of eccentricity of the cam portion 17e, that is, the frame 5 is moved up relative to the support portion 11.

FIG. 10 is a rear view showing the operation of the frame 5. FIG. 10 shows a rotation of the frame 5 with respect to the first pin 16 as a center of rotation in emphasized manner. Although the angle to be adjusted is determined based on the degree of eccentricity of the second cam portion 17e of the second pin 17 and the distance between the first pin 16 and the second pin 17, any angle can be selected if it is in such a range that variations due to dimensional errors of the stand 3, the frame 5, the front cover 6 and the rear cover 7 can be corrected.

As described above, the first bearing portion 20 provided in the body 2, the first pin 16 passing through the first bearing portion 20 so as to be rotatable on the center axis of the first bearing portion and having the first cam portion 16e provided so as to be concentric with the center axis of the first bearing portion, the first opening portion 18 provided in the stand 3 and composed of the first hole 18a through which the head portion 16a of the first pin 16 passes and the second hole 18b into which the first cam portion 16e is fitted, the second bearing portion 21 provided in the body 2, the second pin 17 passing through the second bearing portion 21 so as to be rotatable on the center axis of the second bearing portion and having the second cam portion 17e provided so as to be eccentric to the center axis of the second bearing portion and the second opening portion 19 provided in the stand 3 and composed of the third hole 19a through which the head portion 17a of the second pin passes and the fourth hole 19b into which the second cam portion 17e is fitted, permit a hook function and a positioning function to be provided at the time of assembling the stand 3 with the frame 5 or the body 2 and permit the tilt to be adjusted. Accordingly, while the body 2 of the display device and the stand 3 can be assembled easily, the tilt of the body 2 of the display device 1 can be adjusted by a simple structure.

A first embodiment has been described in the case where the first cam portion 16e of the first pin 16 in the support portion 10 is concentric with the center axis of the bearing portion so that only a function of the center of rotation is provided for tilt adjustment. When a first pin having the same eccentric cam portion as in the second pin 17 is used as the first pin in the support portion 10, the height of the first bearing portion 20 can be adjusted. On this occasion, the maximum tilt adjustable range is twice as much as that in the first embodiment. The tilt can be adjusted in a wider range. The point of difference of a second embodiment from the first embodiment is that the first pin 16 is replaced by a first pin 22.

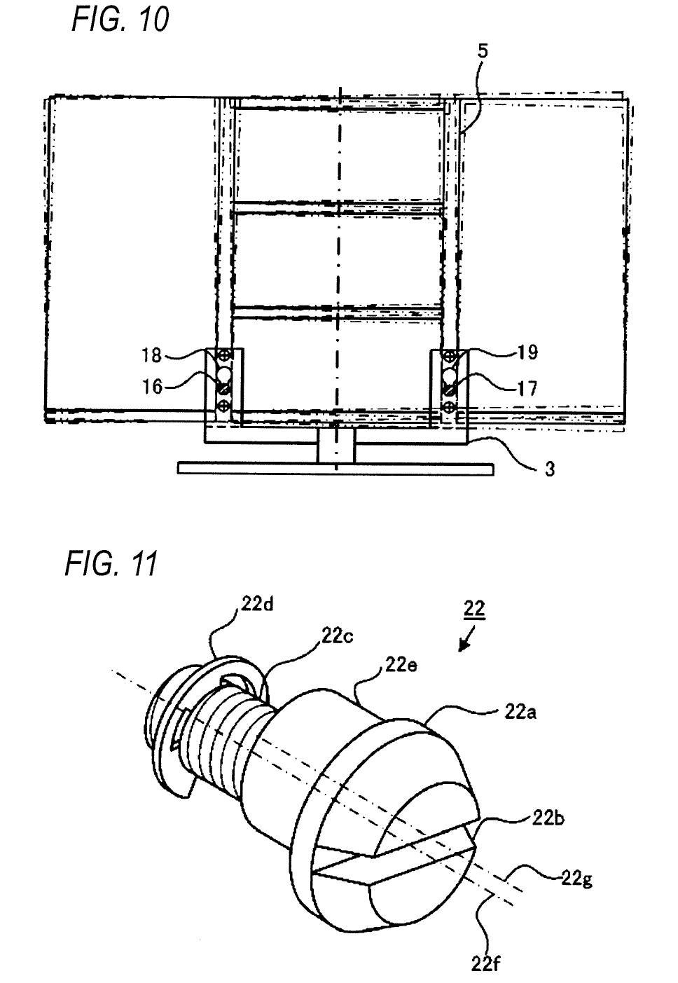

FIG. 11 is a perspective view showing the outline of the first pin 22 in the second embodiment. The shape of the first pin 22 is the same as that of the second pin 17 in the first embodiment. A slot 22b is provided in a head portion 22a so that the first pin 22 can be rotated by a slotted screwdriver. A thread portion 22c is provided on a side opposite to the head portion 22a. A snap ring 22d is provided in the rear of the thread portion 22c. A first cam portion 22e is provided between the head portion 22a and the thread portion 22c. A center axis 22f of the thread portion 22c and a center axis 22g of the first cam portion 22e are eccentric to each other. Incidentally, a snap ring may be used in place of the head portion 22a.

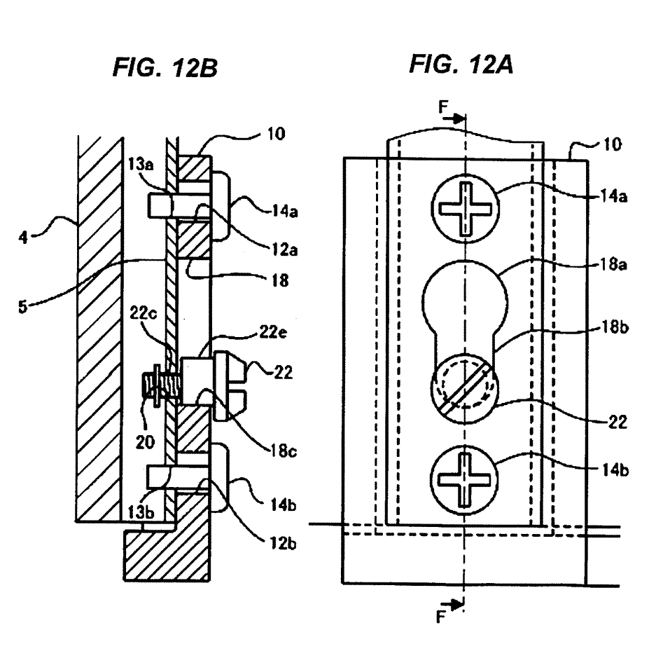

FIGS. 12A and 12B are enlarged views showing a joint portion of the support portion 10 of the stand 3 and the frame 5 in the second embodiment. FIG. 12A is a rear view showing a part of the support portion 10. The first opening portion 18 is composed of the first hole 18a substantially shaped like a circle and the U-shaped second hole 18b connected to a part of the first hole 18a. The first hole 18a is substantially shaped like a circle having a larger diameter than the outer diameter of the head portion 22a of the first pin 22. The second hole 18b is substantially shaped like a U figure having a width smaller than the outer diameter of the head portion 22a of the first pin 22 but larger than the outer diameter of the first cam portion 22e.

FIG. 12B is a sectional view taken along the line F-F in FIG. 12A. The first bearing portion 20 is provided in the frame 5. The first bearing portion 20 is formed as a female thread structure which is complementary to the thread portion 22c of the first pin 22. The thread portion 22c is formed as a screw mechanism capable of being thread-engaged with the first bearing portion 20, so that the first pin 22 can be rotated on the center axis of the first bearing portion 20. After the first pin 22 is thread-engaged with the first bearing portion 20, the snap ring 22d is fitted onto the first pin 22 to prevent the first pin 22 from dropping out from the first bearing portion 20.

As shown in FIG. 12A, the first pin 22 is provided with the first cam portion 22e eccentric to the center axis of the thread portion 22c. By rotating the first pin 22, the first cam portion 22e and a bottom 18c of the first opening portion 18 are brought into contact with each other. As a result, the height of the thread portion 22c changes, so that the height of the first bearing portion 20 changes. As a result, the frame 5 or the body 2 rotates on the second pin 17. After the tilt is adjusted, the setscrews 14a to 14d are tightened to obtain a fixed state. FIGS. 12A and 12B show a state in which the first cam portion 22e is located to be upper than the center axis so that the thread portion 22c is moved down relative to the bottom 18c by the degree of eccentricity of the cam portion 22e, that is, the frame 5 is moved down relative to the support portion 10.

When the frame 5 is moved down relative to the support portion 10 while moved up relative to the support portion 11 or when the frame 5 is moved up relative to the support portion 10 while moved down relative to the support portion 11, the rotation angle of the frame 5 can be made large.

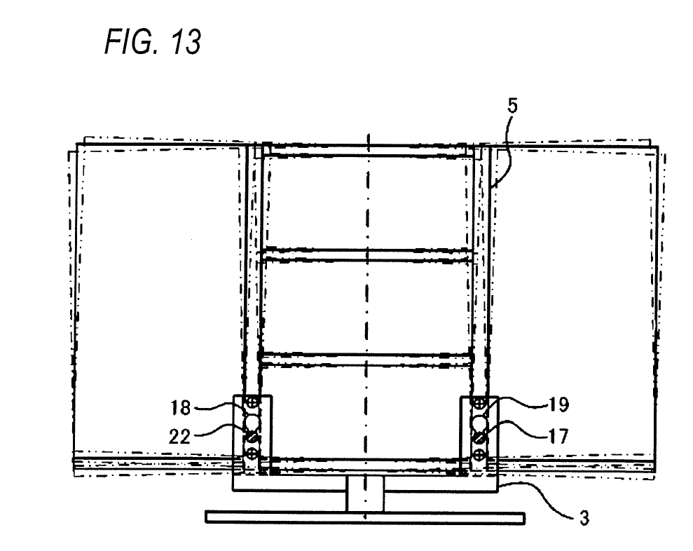

FIG. 13 is a rear view showing the operation of the frame 5 in the second embodiment. FIG. 13 shows a state in which a center of rotation is provided between the first pin 22 and the second pin 17 so that the frame 5 rotates on the center of rotation in emphasized manner.

As described above, the first bearing portion 20 provided in the body 2, the first pin 22 passing through the first bearing portion 20 so as to be rotatable on the center axis of the first bearing portion and having the first cam portion 22e provided so as to be eccentric to the center axis of the first bearing portion, the first opening portion 18 provided in the stand 3 and composed of the first hole 18a through which the head portion 22a of the first pin 22 passes and the second hole 18b into which the first cam portion 22e is fitted, the second bearing portion 21 provided in the body 2, the second pin 17 passing through the second bearing portion 21 so as to be rotatable on the center axis of the second bearing portion and having the second cam portion 17e provided so as to be eccentric to the center axis of the second bearing portion 21 and the second opening portion 19 provided in the stand 3 and composed of the third hole 19a through which the head portion 17a of the second pin 17 passes and the fourth hole 19b into which the second cam portion 17e is fitted, permit a hook function and a positioning function to be provided at the time of assembling the stand 3 with the frame 5 or the body 2 and permit the tilt to be adjusted. Accordingly, while the body 2 of the display device and the stand 3 can be assembled easily, the tilt of the body 2 of the display device 1 can be adjusted by a simple structure. In addition, an adjustment quantity in the tilt adjustment can be kept sufficient.

Incidentally, the invention is not limited to the aforementioned embodiments directly and constituent members can be modified to embody the invention without departing from the gist of the invention in a practical stage. Constituent members disclosed in the aforementioned embodiments may be combined suitably to form various inventions. For example, some constituent members may be removed from all constituent members disclosed in each embodiment. In addition, constituent members disclosed in different embodiments may be combined suitably.

What is claimed is:

1. A display device comprising:
a body;
a stand configured to support the body; and
an adjustment mechanism, provided between the body and the stand, configured to adjust a tilt of the body, the adjustment mechanism comprising:
a first bearing portion provided in the body;
a first pin configured to pass through the first bearing portion so as to be rotatable on a center axis of the first bearing portion, the first pin comprising a first cam portion provided so as to be concentric with the center axis of the first bearing portion;
a first opening portion provided in the stand, the first opening portion being formed with a first hole through which a head portion of the first pin passes and a second hole into which the first cam portion is fitted;
a second bearing portion provided in the body;
a second pin configured to pass through the second bearing portion so as to be rotatable on a center axis of the second bearing portion, the second pin comprising a second cam portion provided so as to be eccentric to the center axis of the second bearing portion; and
a second opening portion provided in the stand, the second opening portion being formed with a third hole through which a head portion of the second pin passes and a fourth hole into which the second cam portion is fitted.

2. The device of claim 1, wherein
the first bearing portion and the first pin are thread-engaged with each other by a screw mechanism so that the first pin can rotate on the center axis of the first bearing portion.

3. The device of claim 1, wherein
the second bearing portion and the second pin are thread-engaged with each other by a screw mechanism so that the second pin can rotate on the center axis of the second bearing portion.

4. The device of claim 1, wherein
the first hole is substantially shaped like a circle having a larger diameter than the outer diameter of the head portion of the first pin whereas the second hole is substantially shaped like a U figure having a width smaller than the outer diameter of the head portion of the first pin but larger than the outer diameter of the first cam portion.

5. The device of claim 1, wherein
the third hole is substantially shaped like a circle having a larger diameter than the outer diameter of the head portion of the second pin whereas the fourth hole is substantially shaped like a U figure having a width smaller than the outer diameter of the head portion of the second pin but larger than the outer diameter of the second cam portion.

6. A display device comprising:
a body;
a stand configured to support the body; and
an adjustment mechanism, provided between the body and the stand, configured to adjust the tilt of the body, the adjustment mechanism comprising:
a first bearing portion provided in the body;
a first pin configured to pass through the first bearing portion so as to be rotatable on a center axis of the first bearing portion, the first pin comprising a first cam portion provided so as to be eccentric to the center axis of the first bearing portion;
a first opening portion provided in the stand, the first opening portion being formed with a first hole through which a head portion of the first pin passes and a second hole into which the first cam portion is fitted;
a second bearing portion provided in the body;
a second pin configured to pass through the second bearing portion so as to be rotatable on a center axis of the second bearing portion, the second pin comprising a second cam portion provided so as to be eccentric to the center axis of the second bearing portion; and
a second opening portion provided in the stand, the second opening portion being formed with a third hole through which a head portion of the second pin passes and a fourth hole into which the second cam portion is fitted.
